(19) United States
(12) Patent Application Publication
(10) Pub. No.: US 2026/0270976 A1
(43) Pub. Date: Sep. 10, 2026

(54) REPORTING OF DELAY STATUS REPORT

(71) Applicant: Lenovo (Beijing) Limited, Beijing (CN)

(72) Inventors: Xiaoying Xu, Shanghai (CN); Lianhai Wu, Beijing (CN); Mingzeng Dai, Shanghai (CN); Jing Han, Shanghai (CN)

(73) Assignee: Lenovo (Beijing) Limited, Beijing (CN)

(21) Appl. No.: 19/165,299

(22) PCT Filed: Sep. 28, 2023
(86) PCT No.: PCT/CN2023/122851

§ 371 Date: Sep. 15, 2025

(51) Int. Cl. H04W 72/12; H04L 43/0852; H04W 28/02; H04W 72/0453; H04W 72/21; H04W 72/563; H04W 74/0833; H04W 80/02

(52) U.S. Cl. CPC H04W 72/12; H04L 43/0852; H04W 28/0278; H04W 72/0453; H04W 72/21; H04W 72/563; H04W 74/0833; H04W 80/02

(57) ABSTRACT

Various aspects of the present disclosure relate to handling of an SR triggered for a DSR. In one aspect, a UE receives, from a base station, at least one SR configuration. The UE triggers a DSR. The UE also triggers a first SR for the triggered DSR based on a first SR configuration among the at least one SR configuration. In turn, the UE transmits the first SR to the base station based on the first SR configuration.

### TECHNICAL FIELD

The present disclosure relates to wireless communications, and more specifically to user equipment (UE), base station and methods for supporting handling of a scheduling request (SR) triggered for a delay status report (DSR).

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as UE, or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

A DSR reporting procedure may be used to provide a base station with delay status of uplink (UL) data. This delay status includes remaining time of UL data, which is based on a value of its associated timer at the time of the first symbol of the physical uplink control channel (PUSCH) transmission in which the DSR is transmitted. The DSR reporting procedure may be also used to provide the base station with the amount of UL data associated with the reported remaining time. The DSR reporting may improve the UL scheduling.

An SR may be used for requesting uplink shared channel (UL-SCH) resources for new transmission. In legacy, SR is triggered based on the triggered buffer status report (BSR), secondary cell (SCell) beam failure recovery and listen before talk failure recovery. To report the DSR to a base station as soon as possible, if there is no UL-SCH resource available for a new transmission, how to support the SR for DSR is required to study.

### SUMMARY

The present disclosure relates to UE, base station and methods that support handling of an SR triggered for a DSR. With the UE, base station and methods, a triggered DSR may be transmitted to a base station as soon as possible.

Some implementations of a UE described herein may include a processor and a transceiver coupled to the processor, wherein the processor is configured to: receive, via the transceiver from a base station, at least one SR configuration; trigger a DSR; trigger a first SR for the triggered DSR based on a first SR configuration among the at least one SR configuration; and transmit the first SR via the transceiver to the base station based on the first SR configuration.

In some implementation, the first SR configuration is associated with transmission of the first SR triggered for the DSR.

In some implementation, each of the at least one SR configuration is associated with one or more logical channels (LCHs), and the first SR configuration is an SR configuration associated with an LCH that triggered the DSR.

In some implementation, each of the at least one SR configuration is associated with one or more logical channel groups (LCGs), and the first SR configuration is an SR configuration associated with an LCG that triggered the DSR.

In some implementation, the processor is configured to trigger the first SR by: based on determining that there is no uplink shared channel (UL-SCH) resources available for a new transmission, triggering the first SR for the triggered DSR.

In some implementation, the processor is configured to trigger the first SR by: based on determining UL-SCH resources available for a new transmission do not meet logical channel prioritization (LCP) mapping restrictions configured for a logical channel that triggered the DSR, triggering the first SR for the triggered DSR.

In some implementation, the processor is configured to trigger the first SR by: triggering the first SR for the triggered DSR based on determining at least one configured uplink grant is configured, a Regular DSR was triggered for a logical channel, and the logical channel is allowed to trigger the first SR if the at least one configured uplink grant is configured.

In some implementation, the processor is configured to trigger the first SR by: based on determining that a time gap between triggering of the DSR and first UL-SCH resource occasion available for a new transmission is greater than or equal to a time threshold, triggering the first SR for the triggered DSR.

In some implementation, the processor is configured to transmit the first SR by: based on determining that a first resource for the first SR triggered for the DSR overlaps in time domain with a second resource for a second SR triggered for a buffer status report (BSR), transmitting the first SR or the second SR based on priorities of the first SR and the second SR.

In some implementation, the processor is configured to transmit the first SR by: based on determining that a first resource for the first SR triggered for the DSR overlaps in time domain with a third resource for an uplink grant, transmitting the first SR or data according to the uplink grant based on priorities of the first SR and the uplink grant.

In some implementation, the processor is further configured to determine a first priority of the first SR as one of the following: a highest priority of LCHs with delay status available for transmission when the DSR is triggered, a priority of a logical channel that triggered the DSR, or a priority of a medium access control control element (MAC CE) for the DSR.

In some implementation, the processor is further configured to: based on determining that the first SR for the DSR was triggered prior to assembly of a medium access control protocol data unit (MAC PDU) comprising a MAC CE for the DSR and the MAC PDU is transmitted, cancel the first SR.

In some implementation, the processor is further configured to: based on determining that at least one uplink grant can accommodate all pending data available for transmission that triggered the DSR, cancel the first SR triggered for the DSR.

In some implementation, the processor is further configured to: initiate an A) procedure for transmission of the first SR for the DSR, the first SR being triggered prior to assembly of a MAC PDU comprising a MAC CE for the DSR; and based on determining that after the initiation of the RA procedure, the MAC PDU is transmitted based on an uplink grant which is not allocated by the RA procedure, stop the RA procedure.

In some implementation, the processor is further configured to: initiate an A) procedure for transmission of the first SR for the DSR, the first SR being triggered prior to assembly of a MAC PDU comprising a MAC CE for the DSR; and based on determining that after the initiation of the RA procedure, at least one uplink grant can accommodate all pending data available for transmission that triggered the DSR, stop the RA procedure.

In some implementation, the MAC CE comprises delay status up to and including the last event that triggered the DSR prior to the assembly of the MAC PDU.

Some implementations of a UE described herein may include a processor and a transceiver coupled to the processor, wherein the processor is configured to: receive, via the transceiver from a base station, at least one random access channel (RACH) configuration including dedicated random access parameters for a DSR; trigger the DSR; trigger an SR for the triggered DSR, initiate an RA procedure due to a pending SR based on a RACH configuration among the at least one RACH configuration; and transmit a RACH request via the transceiver to the base station based on the RACH configuration.

In some implementation, the dedicated random access parameters include at least one of the following: dedicated RACH Occasions, dedicated RACH preamble, or dedicated MSGA resource for the DSR. For example, the dedicated RACH preamble and the dedicated MSGA resource are contention free based resources.

In some implementations, the UE may initiate the RA procedure due to a pending SR for the DSR. The pending SR was triggered prior to assembly of a MAC PDU comprising a MAC CE for the DSR. The RA procedure was initiated by the UE prior to the assembly of the MAC PDU comprising the MAC CE for the DSR.

Some implementations of a base station described herein may include a processor and a transceiver coupled to the processor, wherein the processor is configured to: transmit, via the transceiver to a UE, at least one SR configuration; and receive, via the transceiver from the UE, a first SR triggered for a DSR based on a first SR configuration among the at least one SR configuration.

Some implementations of a method described herein may include: receiving, at a UE from a base station, at least one SR configuration; triggering a DSR; triggering a first SR for the triggered DSR based on a first SR configuration among the at least one SR configuration; and transmitting the first SR to the base station based on the first SR configuration.

Some implementations of a method described herein may include: transmitting, from a base station to a UE, at least one SR configuration; and receiving from the UE, a first SR triggered for a DSR based on a first SR configuration among the at least one SR configuration.

Some implementations of a processor described herein may include at least one memory and a controller coupled with the at least one memory and configured to cause the controller to: receive, from a base station, at least one SR configuration; trigger a DSR; trigger a first SR for the triggered DSR based on a first SR configuration among the at least one SR configuration; and transmit the first SR to the base station based on the first SR configuration.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

FIG. 1 illustrates an example of a wireless communications system that supports handling of an SR triggered for a DSR in accordance with aspects of the present disclosure;

FIG. 2 illustrates a signaling diagram illustrating an example process that supports handling of an SR triggered for a DSR in accordance with aspects of the present disclosure;

FIG. 3 illustrates a signaling diagram illustrating an example process that supports handling of an SR triggered for a DSR in accordance with aspects of the present disclosure;

FIG. 4 illustrates an example of a time gap between triggering of the DSR and first UL-SCH resource occasion available for a new transmission in accordance with aspects of the present disclosure;

FIG. 5 illustrates an example of cancelling of a triggered SR in accordance with aspects of the present disclosure;

FIG. 6 illustrates an example of stop of an RA procedure in accordance with aspects of the present disclosure;

FIG. 7 illustrates a signaling diagram illustrating an example process that supports handling of an SR triggered for a DSR in accordance with aspects of the present disclosure;

FIG. 8 illustrates a signaling diagram illustrating an example process that supports handling of an SR triggered for a DSR in accordance with aspects of the present disclosure;

FIG. 9 illustrates an example of a device that supports handling of an SR triggered for a DSR in accordance with some aspects of the present disclosure;

FIG. 10 illustrates an example of a processor that supports handling of an SR triggered for a DSR in accordance with aspects of the present disclosure; and

FIGS. 11 and 12 illustrate a flowchart of a method that supports handling of an SR triggered for a DSR in accordance with aspects of the present disclosure, respectively.

### DETAILED DESCRIPTION

Principles of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein may be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an example embodiment,” “an embodiment,” “some embodiments,” and the like indicate that the embodiment(s) described may include a particular feature, structure, or characteristic, but it is not necessary that every embodiment includes the particular feature, structure, or characteristic. Moreover, such phrases do not necessarily refer to the same embodiment(s). Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” or the like may be used herein to describe various elements, these elements should not be limited by these terms. These terms are only used to distinguish one element from another element. For example, a first element could also be termed as a second element, and similarly, a second element could also be termed as a first element, without departing from the scope of embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As described above, a DSR reporting procedure may be used to provide a base station with delay status of UL data as well as the amount of UL data associated with the reported remaining time. To report the DSR to the base station as soon as possible, if there is no UL-SCH resource available for a new transmission, how to support the SR for DSR is required to study.

In view of the above, the present disclosure provides a solution that supports handling of an SR triggered for a DSR. In this solution, a UE receives, from a base station, at least one SR configuration. The UE triggers a delay status report (DSR). The UE also triggers a first SR for the triggered DSR based on a first SR configuration among the at least one SR configuration. In turn, the UE transmits the first SR to the base station based on the first SR configuration. With this solution, the triggered DSR may be transmitted to the base station as soon as possible.

Aspects of the present disclosure are described in the context of a wireless communications system.

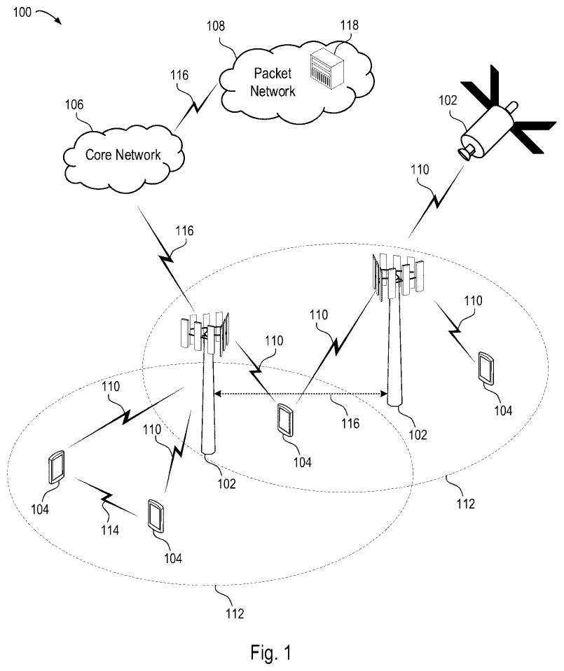

FIG. 1 illustrates an example of a wireless communications system 100 that supports handling of an SR triggered for a DSR in accordance with aspects of the present disclosure. The wireless communications system 100 may include one at least one of network entities 102 (also referred to as network equipment (NE)), one or more terminal devices or UEs 104, a core network 106, and a packet data network 108. The wireless communications system 100 may support various radio access technologies. In some implementations, the wireless communications system 100 may be a 4G network, such as an LTE network or an LTE-advanced (LTE-A) network. In some other implementations, the wireless communications system 100 may be a 5G network, such as an NR network. In other implementations, the wireless communications system 100 may be a combination of a 4G network and a 5G network, or other suitable radio access technology including institute of electrical and electronics engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The network entities 102 may be collectively referred to as network entities 102 or individually referred to as a network entity 102.

The network entities 102 may be dispersed throughout a geographic region to form the wireless communications system 100. One or more of the network entities 102 described herein may be or include or may be referred to as a network node, a base station (BS), a network element, a radio access network (RAN) node, a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an internet-of-things (IOT) device, an internet-of-everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open radio access network (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN intelligent controller (RIC) (e.g., a near-real time RIC (Near-RT RIC), a non-real time RIC (Non-RT RIC)), a service management and orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., radio resource control (RRC), service data adaption protocol (SDAP), packet data convergence protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU 160.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., (=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (510 MHz-7.125 GHZ), FR2 (24.25 GHZ-52.6 GHZ), FR3 (7.125 GHz-24.25 GHz), FR4 (52.6 GHz-114.25 GHZ), FR4a or FR4-1 (52.6 GHz-71 GHz), and FR5 (114.25 GHZ-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

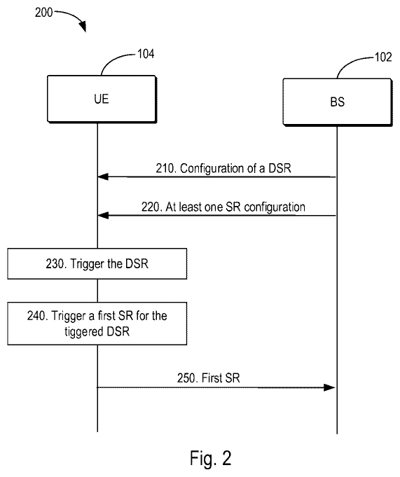

FIG. 2 illustrates a signaling diagram illustrating an example process 200 that supports handling of an SR triggered for a DSR in accordance with aspects of the present disclosure. The process 200 may involve the UE 104 and the base station 102 in FIG. 1. For the purpose of discussion, the process 200 will be described with reference to FIG. 1.

As shown in FIG. 2, the UE 104 receives 210 a configuration of a DSR from the base station 102.

In some implementations, the configuration of the DSR may comprise a remaining time threshold for triggering the DSR for an LCG.

In some implementations, LCGs with delay status available for transmission can be replaced by LCGs with data available for transmission. In other words, some implementations may be applied to at least one of the following: LCGs with delay status available for transmission, or LCGs with data available for transmission.

In some implementations, LCHs with delay status available for transmission can be replaced by LCHs with data available for transmission. In other words, some implementations may be applied to at least one of the following: LCHs with delay status available for transmission can be replaced by LCHs with data available for transmission.

In addition, the UE 104 receives 220 at least one SR configuration from the base station 102.

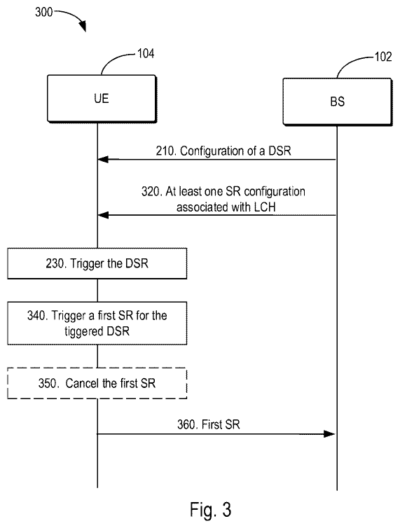

In some implementations, each of the at least one SR configuration may be used to configure the parameters for the dedicated SR resources. Each of the at least one SR configuration may consist of a set of physical uplink control channel (PUCCH) resources for SR across different bandwidth parts (BWPs) and cells. Some examples of the at least one SR configuration will be described later with reference to FIGS. 3 to 8.

In some implementations, the base station 102 may configure the following parameters for the SR procedure: sr-ProhibitTimer (per SR configuration) and sr-TransMax (per SR configuration).

In some implementations, the sr-ProhibitTimer may be a timer for SR transmission on PUCCH. The sr-ProhibitTimer is used to prevent UE from sending SR again and again. Value is in ms. For example, value ms1 corresponds to 1 ms, value ms2 corresponds to 2 ms, and so on. When the field is absent, the UE 104 applies the value 0.

In some implementations, the sr-TransMax represents a maximum number of SR transmissions. For example, value n4 corresponds to 4, value n8 corresponds to 8, and so on.

In turn, the UE 104 triggers 230 the DSR based on the configuration of the DSR.

In some implementations, if an LCG is configured with allowed reporting of a DSR, the UE 104 triggers the DSR when remaining time of UL data in the LCG becomes less than or equal to its associated remaining time threshold. The DSR trigged based on a threshold may be named as a regular DSR. If a DSR is triggered for an LCG, the LCG has a DSR available for transmission.

In some implementations, if the LCG has a DSR available for transmission, the LCG has UL data and remaining time of at least one of the data in the LCG becomes less than or equal to its associated remaining time threshold.

In some implementations, UL data represents UL data available and pending for transmission in PDCP and/or RLC.

In some implementations, the LCG has a DSR available for transmission or DS available for transmission represents or implies the LCG has data available for transmission in PDCP and/or RLC and remaining time of one of the data in the LCG becomes less than or equal to its associated remaining time threshold of the LCG.

In some implementations, the UE 104 calculates the remaining time based on a value of a PDCP discard timer. These calculated values for the different PDU sets or PDUs in the different logical channels can then be reported.

In some implementations, the UE 104 may receive a PDU set discard indication for a data radio bearer (DRB) from the base station 102. The indication indicates that all PDUs in a PDU set are to be discarded if any of the PDUs is not transmitted to the base station 102 successfully. In such implementations, the PDUs in the PDU set may have the same remaining time. For example, the remaining time of the PDUs may be the same as remaining time of a PDU in the PDU set which is first arrived at a PDCP entity of the UE 104.

The UE 104 triggers 240 a first SR for the triggered DSR based on a first SR configuration among the at least one SR configuration.

Then, the UE 104 transmits 250 the first SR to the base station 102 based on the first SR configuration.

FIG. 3 illustrates a signaling diagram illustrating an example process 300 that supports handling of an SR triggered for a DSR in accordance with aspects of the present disclosure. The process 300 may be considered as an example implementation of the process 300. The process 300 may involve the UE 104 and the base station 102 in FIG. 1. For the purpose of discussion, the process 300 will be described with reference to FIG. 1.

Actions 210 and 230 in the process 300 are similar to those in the process 200. Details of these actions are omitted for brevity.

The process 300 is different from the process 200 in actions 320, 340, 350 and 360.

Specifically, the UE 104 receives 320 at least one SR configuration from the base station 102. Each of the at least one SR configuration is associated with one or more LCHs. The first SR configuration for the triggered first SR is an SR configuration associated with an LCH that triggered the DSR. In other words, an SR configuration of the LCH that triggered the DSR (if such a configuration exists) is considered as corresponding SR configuration for the triggered first SR. For an LCH, at most one PUCCH resource for SR is configured per BWP.

In some implementations, the SR configuration of the LCH that triggered the DSR is the same as the SR configuration of the LCH that triggered a BSR. That is, the SR configuration for the BSR and the SR configuration for the DSR shares the same resource.

Alternatively, in some implementations, the SR configuration of the LCH that triggered the DSR is separate from the SR configuration of the LCH that triggered a BSR.

Alternatively, in some implementations, an SR configuration of an LCG that triggered the DSR (if such a configuration exists) is considered as corresponding SR configuration for the triggered first SR. For an LCG, at most one PUCCH resource for SR is configured per BWP.

If the DSR is triggered and if there is no UL-SCH resource available for a new transmission, the UE 104 triggers 340 the first SR for the triggered DSR. For example, if the DSR is triggered and if there is no UL-SCH resources available for transmission of the triggered DSR, the UE 104 triggers 340 the first SR for the triggered DSR.

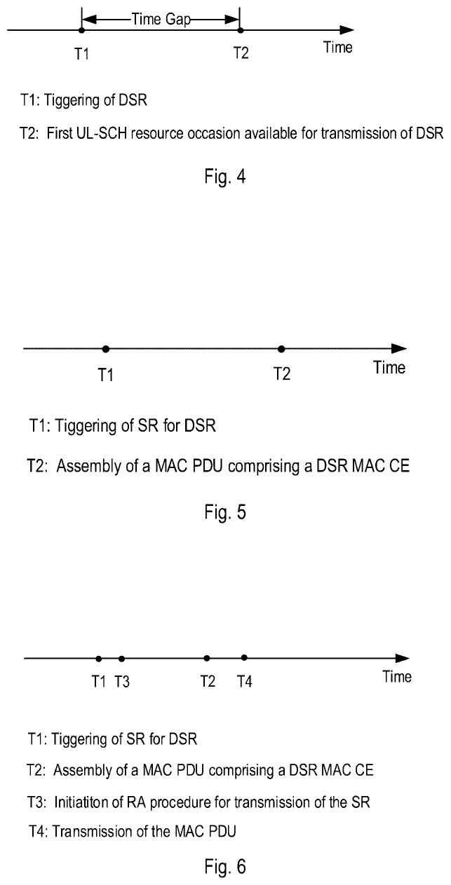

Alternatively, in some implementations, if the DSR is triggered and if a time gap between triggering of the DSR and first UL-SCH resource occasion available for a new transmission is greater than or equal to a time threshold, the UE 104 triggers the first SR for the triggered DSR. For example, if the DSR is triggered and if a time gap between triggering of the DSR and first UL-SCH resource occasion available for transmission of the triggered DSR is greater than or equal to a time threshold, the UE 104 triggers 340 the first SR for the triggered DSR. This will be described with reference to FIG. 4.

FIG. 4 illustrates an example of a time gap between triggering of the DSR and first UL-SCH resource occasion available for a new transmission in accordance with aspects of the present disclosure.

As shown in FIG. 4, a DSR is triggered at time T1, and the first UL-SCH resource occasion available for transmission of the DSR is at time T2. It shall be noted that there may be multiple UL-SCH resource occasions available for transmission of the DSR, the UL-SCH resource occasion available for transmission of the DSR at time T2 is the earliest (i.e., the first or initial) among the multiple UL-SCH resource occasions. For example, T2 is the start symbol of the first UL-SCH resource occasion available for a new transmission.

If a time gap between T1 and T2 is greater than or equal to a time threshold, the UE 104 triggers the first SR for the triggered DSR.

In some implementations, the time threshold may be configured by the base station 102. This may be configured per LCG or LCH. For example, the time threshold may be equal to a remaining time threshold for triggering the DSR, i.e., the time threshold may reuse the remaining time threshold for triggering the DSR. Alternatively, the time threshold may be separate from the remaining time threshold for triggering the DSR.

Alternatively, in some implementations, the time threshold may be equal to the shortest remaining time threshold of the LCG if the UE 104 triggers the DSR for the LCG, if there are multiple remaining time thresholds configured for triggering the DSR for an LCG.

Alternatively, in some implementations, the time threshold may be equal to the shortest remaining time among remaining time of data in a LCG with delay status report available for transmission. Data with delay status report available for transmission represents remaining time of the data in a LCG is less than or equal to its associated remaining time threshold of the LCG.

Alternatively, in some implementations, the time threshold may be equal to the shortest remaining time among remaining time of data in any LCG with delay status report available for transmission. Data with delay status report available for transmission represents remaining time of the data in any LCG is less than or equal to its associated remaining time threshold of the LCG.

Alternatively, in some implementations, the time threshold may be equal to the shortest remaining time among remaining time of data with the highest LCH priority and with delay status report available for transmission.

Alternatively, in some implementations, if the DSR is triggered and if UL-SCH resources available for a new transmission do not meet logical channel prioritization (LCP) mapping restrictions configured for a logical channel that triggered the DSR, the UE 104 triggers 340 the first SR for the triggered DSR. For example, if the DSR is triggered and if UL-SCH resources available for transmission of the DSR do not meet LCP mapping restrictions configured for a logical channel that triggered the DSR, the UE 104 triggers the first SR for the triggered DSR.

Alternatively, in some implementations, if at least one configured UL grant is configured, a DSR was triggered for a logical channel, and the logical channel is allowed to trigger the first SR if the at least one configured UL grant is configured, the UE 104 triggers 340 the first SR for the triggered DSR. A DSR was triggered for a logical channel, i.e., the UE 104 triggers the DSR when remaining time of UL data of the logical channel in the LCG becomes less than or equal to its associated remaining time threshold.

For example, if a DSR has been triggered:
if there is no UL-SCH resource available for a new transmission; or
if the MAC entity of the UE 104 is configured with configured UL grant(s) and the DSR was triggered for a LCH for which logicalChannelSR-Mask is set to false; or
if the UL-SCH resources available for a new transmission do not meet the LCP mapping restrictions configured for the LCH that triggered the DSR:
   the UE 104 triggers an SR (such as the first SR).

In some implementations, the UE 104 does not trigger 340 the first SR for the triggered DSR if logicalChannelSR-DelayTimer is running.

In some implementations, when an SR is triggered, the SR shall be considered as pending until it is cancelled. In some implementations, triggering an SR may be used to generate a pending SR for transmission.

In some implementations, the following UE variables may be used for the scheduling request procedure: SR_COUNTER (per SR configuration). SR_COUNTER represents the number of the times that a pending SR has been transmitted.

In some implementations, for each SR configuration corresponding to each pending SR, the UE 104 transmits SR to the base station 102 on one valid PUCCH resource for each pending SR and increments SR_COUNTER by 1 if SR_COUNTER less than the sr-TransMax. For example, for the first SR configuration corresponding to the pending first SR, the UE 104 transmits 300 the first SR to the base station 102 on one valid PUCCH resource for the pending first SR and increments SR_COUNTER by 1 if SR_COUNTER less than the sr-TransMax.

In some implementations, if SR_COUNTER equal to or more than the sr-TransMax, the UE 104 may perform the following one or more actions:
notify a radio resource control (RRC) layer to release PUCCH for all Serving Cells;
notify the RRC layer to release sounding reference signal (SRS) for all Serving Cells;
clear any configured downlink assignments and UL grants;
clear any PUSCH resources for semi-persistent channel status information (CSI) reporting; or
initiate a Random Access procedure on the SpCell and cancel all pending SRs.

In some implementations, if an SR is triggered and there are no other SRs pending corresponding to the same SR configuration, the MAC entity of the UE 104 shall set the SR_COUNTER of the corresponding SR configuration to 0.

In some implementations, a first resource for the first SR triggered for the DSR may overlap in time domain with a third resource for an UL grant. In such implementations, the UE 104 may transmit 760 the first SR or data according to the UL grant based on priorities of the first SR and the UL grant. In such implementations, the UE 104 may prioritize transmission of the first SR for DSR if a priority of the first SR trigged for the DSR is higher than a priority of the overlapped UL grant.

For example, if the MAC entity is configured with Ich-basedPrioritization, and the PUCCH resource for the SR transmission occasion for the pending SR triggered overlaps with any other UL-SCH resource(s), the UE 104 may prioritize transmission of the first SR for DSR if a priority of the first SR trigged for the DSR is higher than a priority of the overlapped UL grant. The Ich-basedPrioritization is used to indicate the UE 104 to prioritize between overlapping grants and between scheduling request and overlapping grants based on LCH priority.

In some implementations, the UE 104 may consider that the LCH that triggered the DSR is the highest priority LCH that has delay status report available for transmission at the time the DSR is triggered. In such implementations, the UE 104 may determine a first priority of the first SR triggered for the DSR as a highest priority of LCHs with delay status available for transmission when the DSR is triggered. For example, both the data of LCH #1 and LCH #2 in LCG #1 trigger DSRs, and a priority of LCH #1 is higher than a priority of LCH #2. The UE 104 may consider that the LCH that triggered the DSR is LCH #1. Thus, the UE 104 triggers the first SR for LCH #1 based on the SR configuration of LCH #1. In turn, the UE 104 determines the first priority of the first SR triggered for the triggered DSR as the priority of LCH #1.

Alternatively, in some implementations, the UE 104 may consider that the LCH that triggered the DSR is the LCH that triggers the DSR at the time the DSR is triggered. In such implementations, the UE 104 may determine a first priority of the first SR triggered for the DSR as a priority of the LCH that triggered the DSR. For example, both the data of LCH #1 and LCH #2 in LCG #1 trigger DSRs. The UE 104 separately triggers a first SR for LCH #1 based on the SR configuration of LCH #1 and triggers a second SR for LCH #2 based on the SR configuration of LCH #2. The UE 104 may determine a priority of the first SR for LCH #1 as a priority of LCH #1. The UE 104 may determine a priority of the second SR for LCH #2 as a priority of LCH #2.

In some implementations, the UE 104 may consider that the LCH that triggered the DSR is the highest priority LCH that has data available for transmission belong to an LCG at the time when the DSR is triggered for the LCG.

In some implementations, the UE 104 may consider that the LCH that triggered the DSR is the highest priority LCH that has data available for transmission belong to an LCG at the time when the DSR is triggered.

Alternatively, in some implementations, the UE 104 may determine a first priority of the first SR triggered for the DSR as a priority of a medium access control control element (MAC CE) for the DSR. Hereinafter, a MAC CE for a DSR is also referred to as a DSR MAC CE for brevity. The priority order for the DSR MAC CE the other MAC CEs in the section 5.4.3.1.3 in TS 38.321, data from UL-CCCH and data from any Logical Channel except data from UL-CCCH may be defined in TS 38.321. For example, priority of DSR MAC CE may be defined as the following:

Logical channels shall be prioritised in accordance with
the following order (highest priority listed first):

C-RNTI MAC CE or data from UL-CCCH;
Configured Grant Confirmation MAC CE or MAC CEs for BFR or
Multiple Entry Configured Grant Confirmation MAC CE;
Sidelink Configured Grant Confirmation MAC CE;
LBT failure MAC CE;
MAC CE for Timing Advance Report;
MAC CE for SL-BSR prioritized according to clause 5.22.1.6;
MAC CE for DSR;
MAC CE for BSR, with exception of BSR included for padding;
Single Entry PHR MAC CE or Multiple Entry PHR MAC CE;
MAC CE for the number of Desired Guard Symbols;
MAC CE for Pre-emptive BSR;
MAC CE for SL-BSR, with exception of SL-BSR prioritized according to
clause 5.22.1.6 and SL-BSR included for padding;
data from any Logical Channel, except data from UL-CCCH;
MAC CE for Recommended bit rate query;
MAC CE for BSR included for padding;
MAC CE for SL-BSR included for padding.

In some implementations, the UE 104 may determine a priority of a DSR MAC CE as a first highest priority of LCHs with delay status available for transmission in a first set of LCGs with delay status available for transmission. The first set of LCGs comprises one or more LCGs.

In some implementations, the UE may determine the priority of the UL grant as the highest priority among priorities of the LCHs that are multiplexed or have data available that can be multiplexed in a medium access control protocol data unit (MAC PDU), according to the mapping restrictions. The priority of a UL grant for which no data for LCHs is multiplexed or can be multiplexed in the MAC PDU is lower than either the priority of a UL grant for which data for any LCHs is multiplexed or can be multiplexed in the MAC PDU or the priority of the LCH triggering an SR.

In some implementations, if the MAC entity of the UE 104 is configured with Ich-basedPrioritization, and the PUCCH resource for the SR transmission occasion for the pending SR triggered overlaps with any other UL-SCH resource(s), and the priority of the LCH that triggered SR is higher than the priority of the UL grant(s) for any UL-SCH resource(s) where the UL grant was not already de-prioritized and its simultaneous transmission with the SR is not allowed by configuration of simultaneous PUCCH-PUSCH, the UE 104 may consider the SR transmission as a prioritized SR transmission and consider the other overlapping UL grant, if any, as a de-prioritized UL grant.

In some implementations, a first resource for the first SR triggered for the DSR may overlap in time domain with a second resource for a second SR triggered for a BSR. In such implementations, the UE 104 may transmit the first SR or the second SR based on priorities of the first SR and the second SR. In such implementations, the UE 104 may prioritize transmission of the first SR triggered for DSR or transmission of the second SR triggered for BSR based on a first priority of the first SR and a second priority of the second SR.

As described above, the UE 104 may determine a priority of a DSR MAC CE as a first highest priority of LCHs with delay status available for transmission in a first set of LCGs with delay status available for transmission. The first set of LCGs comprises one or more LCGs.

In addition, the UE 104 may determine a priority of a MAC CE for a BSR as a second highest priority of LCHs with data available for transmission in a second set of LCGs with data available for transmission. The second set of LCGs comprises one or more LCGs. Hereinafter, a MAC CE for a BSR is also referred to as a BSR MAC CE for brevity.

In turn, the UE 104 may determine the first priority of the first SR triggered for DSR as the priority of the DSR MAC CE. Similarly, the UE 104 may determine the second priority of the second SR triggered for BSR as the priority of the BSR MAC CE.

In such implementations, when the MAC entity has pending SR for DSR and the MAC entity has one or more PUCCH resources of pending SR for BSR overlapping with PUCCH resource for DSR for the SR transmission occasion, the UE 104 may consider the SR transmission for DSR as a prioritized SR transmission if the priority of the priority of the SR trigged for the DSR is higher than or equal to the the priority of the SR trigged for the BSR. On the other hand, the UE 104 may consider the SR transmission for DSR as a de-prioritized SR transmission if the priority of the priority of the SR trigged for the DSR is lower than the priority of the SR trigged for the BSR.

In such implementations, when the MAC entity has pending SR for DSR and the MAC entity has one or more PUCCH resources of pending SR for BSR overlapping with PUCCH resource for DSR for the SR transmission occasion, it may be up to the UE 104 to select which SR to transmit. The selection of which valid PUCCH resource for SR to signal SR on when the MAC entity has more than one overlapping valid PUCCH resource for the SR transmission occasion is left to UE implementation.

For example, as long as at least one SR is pending, the MAC entity shall for each pending SR:
1> for the SR configuration corresponding to the pending SR:
   2> when the MAC entity has an SR transmission occasion on the valid PUCCH resource for SR configured; and
   2> if sr-ProhibitTimer is not running at the time of the SR transmission occasion; and
   2> if the PUCCH resource for the SR transmission occasion does not overlap with a measurement gap:
      3> if the PUCCH resource for the SR transmission occasion overlaps with neither a UL-SCH resource whose simultaneous transmission with the SR is not allowed by configuration of simultaneousPUCCH-PUSCH nor an SL-SCH resource; or
      3> if the MAC entity is able to perform this SR transmission simultaneously with the transmission of the SL-SCH resource; or
      3> if the MAC entity is configured with Ich-basedPrioritization, and the PUCCH resource for the SR transmission occasion does not overlap with the PUSCH duration of an uplink grant received in a Random Access Response or with the PUSCH duration of an uplink grant addressed to Temporary Cell-Radio Network Temporary Identifier (C-RNTI) or with the PUSCH duration of a MSGA payload, and the PUCCH resource for the SR transmission occasion for the pending SR triggered overlaps with any other UL-SCH resource(s), and the physical layer can signal the SR on one valid PUCCH resource for SR, and the priority of the LCH that triggered SR is higher than the priority of the uplink grant(s) for any UL-SCH resource(s) where the uplink grant was not already de-prioritized and its simultaneous transmission with the SR is not allowed by configuration of simultaneousPUCCH-PUSCH:
         4> consider the SR transmission as a prioritized SR transmission.
         4> consider the other overlapping uplink grant(s), if any, as a de-prioritized uplink grant(s);
         4> if SR_COUNTER<sr-TransMax:
         5> instruct the physical layer to signal the SR on one valid PUCCH resource for SR;
         5> if LBT failure indication is not received from lower layers:
         6> increment SR_COUNTER by 1;
         6> start the sr-ProhibitTimer.
         4> else:
      3> else:
         4> consider the SR transmission as a de-prioritized SR transmission.

Optionally, in some implementations, before transmitting 360 the first SR, the UE 104 may cancel 350 the first SR.

In some implementations, if the first SR for the DSR was triggered prior to assembly of a MAC PDU comprising a MAC CE for the triggered DSR (i.e., a DSR MAC CE) and the MAC PDU is transmitted, the UE 104 may cancel the first SR. In such implementations, the DSR MAC CE may comprise delay status up to and including the last event that triggered the DSR prior to the assembly of the MAC PDU.

In such implementations, all pending SR(s) for DSR triggered according to the DSR procedure prior to assembly of the MAC PDU shall be cancelled when the MAC PDU is transmitted and this PDU includes a DSR MAC CE which contains delay status up to (and including) the last event that triggered a DSR prior to the MAC PDU assembly. Additionally, the UE 104 may stop each respective sr-ProhibitTimer for all pending SR(s). This will be described with reference to FIG. 5.

FIG. 5 illustrates an example of cancelling of a triggered SR in accordance with aspects of the present disclosure.

As shown in FIG. 5, the first SR is triggered at time T1 for a triggered DSR. Assembly of a MAC PDU comprising a MAC CE for the triggered DSR (i.e., a DSR MAC CE) occurs at time T2 and the MAC PDU is transmitted at time T2 or after the time T2. The DSR MAC CE may comprise delay status up to and including the last event that triggered the DSR prior to the assembly of the MAC PDU (i.e., prior to time T2). In this case, the UE 104 may cancel the first SR. Additionally, the UE 104 may stop sr-ProhibitTimer for the first SR.

Alternatively, in some implementations, if at least one UL grant can accommodate all pending data available for transmission that triggered the DSR, the UE 104 may cancel the first SR triggered for the DSR. In such implementations, all pending SR(s) for DSR triggered according to the DSR procedure shall be cancelled and each respective sr-ProhibitTimer shall be stopped when the UL grant(s) can accommodate all pending data available for transmission that triggered DSR. Additionally, the UE 104 may stop each respective sr-ProhibitTimer for all pending SR(s).

For example, for each pending SR triggered according to the DSR procedure for a Serving Cell, if this SR was triggered by DSR procedure prior to the MAC PDU assembly and a MAC PDU containing the relevant DSR MAC CE is transmitted, the UE 104 shall cancel the pending SR and stop the corresponding sr-ProhibitTimer, if running.

Alternatively, in some implementations, the UE 104 may cancel the first SR trigged by the DSR if the corresponding DSR is cancelled.

In some implementations, the UE 104 may initiate a random access (RA) procedure due to a pending SR for the DSR. The pending SR was triggered prior to assembly of a MAC PDU comprising a MAC CE for the DSR. The RA procedure was initiated by the UE 104 prior to assembly of a MAC PDU comprising a MAC CE for the DSR. After the initiation of the RA procedure, if the MAC PDU is transmitted based on an uplink grant which is not allocated by the RA procedure if ongoing, the UE 104 may stop the RA procedure.

In some implementations, the UE 104 may initiate a random access (RA) procedure due to a pending SR for the DSR. The RA procedure was initiated by the UE 104 prior to assembly of a MAC PDU comprising a MAC CE for the DSR. After the initiation of the RA procedure, if at least one UL grant which is not allocated by the RA procedure can accommodate all pending data available for transmission that triggered the DSR, the UE 104 may stop the RA procedure if ongoing. This will be described with reference to FIG. 6.

FIG. 6 illustrates an example of stop of an RA procedure in accordance with aspects of the present disclosure.

As shown in FIG. 6, an SR is triggered at time T1 for a triggered DSR.

Assembly of a MAC PDU comprising a MAC CE for the triggered DSR (i.e., a DSR MAC CE) occurs at time T2. The DSR MAC CE may comprise delay status up to and including the last event that triggered the DSR prior to the assembly of the MAC PDU (i.e., prior to time T2). If no valid PUCCH resources configured, the UE 104 initiates, at time T3, an RA procedure due to the pending SR. The MAC PDU comprising the DSR MAC CE is transmitted at time T4. Alternatively, after the initiation of the RA procedure, the UE 104 may determine, at time T4, at least one UL grant can accommodate all pending data available for transmission that triggered the DSR. In this case, the UE 104 may stop the RA procedure.

In some implementations, the UL grant used for transmission of the MAC PDU or all pending data available for transmission that triggered the DSR may be different from a UL grant provided by a Random Access Response or a UL grant for the transmission of the MSGA payload.

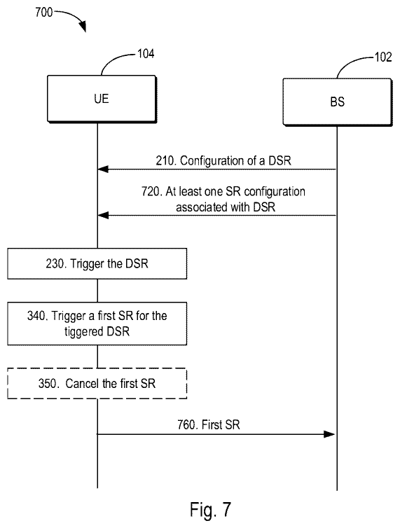

FIG. 7 illustrates a signaling diagram illustrating an example process 700 that supports handling of an SR triggered for a DSR in accordance with aspects of the present disclosure. The process 700 may be considered as an example implementation of the process 200. The process 700 may involve the UE 104 and the base station 102 in FIG. 1. For the purpose of discussion, the process 700 will be described with reference to FIG. 1.

Actions 210 and 230 in the process 700 are similar to those in the process 200. Actions 340 and 350 in the process 700 are similar to those in the process 300. Details of these actions are omitted for brevity.

The process 700 is different from the processes 200 and 300 in actions 720 and 760.

Specifically, the UE 104 receives 720 at least one SR configuration from the base station 102. The at least one SR configuration comprises a first SR configuration which is associated with transmission of the first SR triggered for the DSR. Table 1 gives an example of the first SR configuration which is associated with transmission of the first SR triggered for the DSR. Table 2 gives an example of parameters in the first SR configuration. Table 3 gives explanations of the parameters in Table 2.

TABLE 1

MAC-CellGroupConfig: ::= SEQUENCE {
schedulingRequestID-DSR SchedulingRequestId
}
schedulingRequestID-DSR
Indicates the scheduling request configuration applicable
for Delay Status Report

```
TABLE 2
SchedulingRequestConfig ::= SEQUENCE {
  schedulingRequestToAddModList SEQUENCE (SIZE
(1..maxNrofSR-ConfigPerCellGroup)) OF SchedulingRequestToAddMod,
  schedulingRequestToReleaseList SEQUENCE (SIZE
(1..maxNrofSR-ConfigPerCellGroup)) OF SchedulingRequestId
}
SchedulingRequestToAddMod ::= SEQUENCE {
  schedulingRequestId SchedulingRequestId,
  sr-ProhibitTimer ENUMERATED {ms1, ms2, ms4, ms8, ms16,
ms32, ms64, ms128},
    sr-TransMax ENUMERATED { n4, n8, n16, n32, n64,
spare3, spare2, spare1}
}
schedulingRequestId
Used to modify a SR configuration and to indicate, in
LogicalChannelConfig, the SR configuration to which a LCH is mapped
and to indicate, in SchedulingRequestresourceConfig, the SR
configuration for which a scheduling request resource is used.
sr-ProhibitTimer
    Timer for SR transmission on PUCCH in TS 38.321 [3]. Value is
    in ms.
    Value ms1 corresponds to 1ms, value ms2 corresponds to 2ms, and
    so on.
    When the field is absent, the UE applies the value 0.
sr-TransMax
    Maximum number of SR transmissions as described in TS 38.321 [3].
    Value n4 corresponds to 4, value n8 corresponds to 8, and so on.
schedulingRequestToAddModList
List of Scheduling Request configurations to add or modify.
schedulingRequestToReleaseList
List of Scheduling Request configurations to release.
```

Similar to the process 300, in the process 700, a first resource for the first SR triggered for the DSR may overlap in time domain with a third resource for an UL grant. In such implementations, the UE 104 may transmit 760 the first SR or data according to the UL grant based on priorities of the first SR and the UL grant. In such implementations, the UE 104 may prioritize transmission of the first SR for DSR if a priority of the first SR trigged for the DSR is higher than a priority of the overlapped UL grant.

Similar to the process 300, in the process 700, a first resource for the first SR triggered for the DSR may overlap in time domain with a second resource for a second SR triggered for a BSR. In such implementations, the UE 104 may transmit 760 the first SR or the second SR based on priorities of the first SR and the second SR. In such implementations, the UE 104 may prioritize transmission of the first SR triggered for DSR or transmission of the second SR triggered for BSR based on a first priority of the first SR and a second priority of the second SR.

Alternatively, if the first resource for the first SR triggered for the DSR overlaps in time domain with the second resource for the second SR triggered for the BSR, the UE 104 may prioritize transmission of the first SR triggered for DSR or prioritize transmission of the second SR triggered for BSR.

For example, when the MAC entity has pending SR for DSR and the MAC entity has one or more PUCCH resources of pending SR for BSR overlapping with PUCCH resource for DSR for the SR transmission occasion, the MAC entity considers only the PUCCH resource for DSR as valid, i.e., prioritizes the SR transmission for DSR. Alternatively, the MAC entity considers only the PUCCH resource for Buffer Status Report as valid, i.e., de-prioritizing the SR transmission for DSR. Alternatively, the selection of which valid PUCCH resource for SR to signal SR on when the MAC entity has more than one overlapping valid PUCCH resource for the SR transmission occasion is left to UE implementation.

In some implementations, the UE 104 may prioritize transmission of an SR for Beam Failure Recovery over transmission of the first SR for DSR.

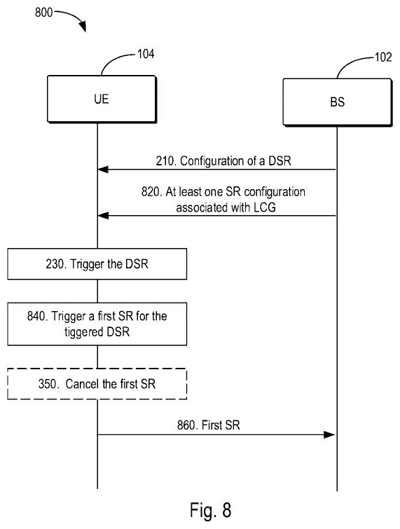

FIG. 8 illustrates a signaling diagram illustrating an example process 800 that supports handling of an SR triggered for a DSR in accordance with aspects of the present disclosure. The process 800 may be considered as an example implementation of the process 200. The process 800 may involve the UE 104 and the base station 102 in FIG. 1. For the purpose of discussion, the process 800 will be described with reference to FIG. 1.

Actions 210 and 230 in the process 800 are similar to those in the process 200. The action 350 in the process 800 is similar to that in the process 300. Details of these actions are omitted for brevity.

The process 800 is different from the processes 200 and 300 in actions 820, 840 and 860.

Specifically, the UE 104 receives 820 at least one SR configuration from the base station 102. Each of the at least one SR configuration is associated with one or more LCGs. The one or more LCGs may be configured with reporting of DSR. The first SR configuration is an SR configuration associated with an LCG that triggered the DSR. In other words, the SR configuration of the LCG that triggered the DSR (if such a configuration exists) is considered as corresponding SR configuration for the triggered SR. For an LCG, at most one PUCCH resource for SR is configured per BWP. Table 4 gives an example of the first SR configuration of the LCG that triggered the DSR.

TABLE 4

```
SchedulingRequestIDofLCGs
  >LCGO
  >schedulingRequestID
    >LCG1
    >schedulingRequestID
```

In some implementations, the base station 102 may configure the following parameters for the SR procedure: sr-ProhibitTimer (per SR configuration) and sr-TransMax (per SR configuration).

If the DSR is triggered and if there is no UL-SCH resources available for a new transmission, the UE 104 triggers 840 the first SR for the triggered DSR. For example, if the DSR is triggered and if there is no UL-SCH resources available for transmission of the triggered DSR, the UE 104 triggers 840 the first SR for the triggered DSR.

Alternatively, in some implementations, if the DSR is triggered and if a time gap between triggering of the DSR and first UL-SCH resource occasion available for a new transmission is greater than or equal to a time threshold, the UE 104 triggers the first SR for the triggered DSR. For example, if the DSR is triggered and if a time gap between triggering of the DSR and first UL-SCH resource occasion available for transmission of the triggered DSR is greater than or equal to a time threshold, the UE 104 triggers 840 the first SR for the triggered DSR.

Alternatively, in some implementations, if the DSR is triggered and if UL-SCH resources available for a new transmission do not meet LCP mapping restrictions configured for a logical channel that triggered the DSR, the UE 104 triggers 840 the first SR for the triggered DSR. For example, if the DSR is triggered and if UL-SCH resources available for transmission of the DSR do not meet LCP mapping restrictions configured for a logical channel that triggered the DSR, the UE 104 triggers the first SR for the triggered DSR.

In some implementations, if multiple LCG triggers DSRs, each of the DSRs may separately trigger an SR for a respective one of the multiple LCGs, or only the LCG with the highest priority LCH with the DSR being triggered may trigger an SR.

In some implementations, if multiple LCHs triggers DSRs, the UE 104 may consider that the LCH that triggered the DSR is the highest priority LCH that has delay status available for transmission. Alternatively, the UE 104 may consider that the LCH that triggered the DSR includes all LCHs that have delay status available for transmission.

In some implementations, the UE 104 may determine a first priority of the first SR triggered for the DSR as a highest priority of LCHs in all LCGs with delay status available for transmission when the DSR is triggered.

In some implementations, a first resource for the first SR triggered for the DSR may overlap in time domain with a third resource for an UL grant. In such implementations, the UE 104 may transmit 860 the first SR or data according to the UL grant based on priorities of the first SR and the UL grant. In such implementations, the UE 104 may prioritize transmission of the first SR for DSR if the first priority of the first SR trigged for the DSR is higher than a priority of the overlapped UL grant.

For example, if the MAC entity is configured with Ich-basedPrioritization, and the PUCCH resource for the SR transmission occasion does not overlap with the PUSCH duration of a UL grant received in a Random Access Response or with the PUSCH duration of a UL grant addressed to Temporary C-RNTI or with the PUSCH duration of a MSGA payload, and the PUCCH resource for the SR transmission occasion for the pending SR triggered overlaps with any other UL-SCH resource(s), and the physical layer can signal the SR on one valid PUCCH resource for SR, and the priority of the triggered SR is higher than the priority of the UL grant(s) for any UL-SCH resource(s) where the UL grant was not already de-prioritized and its simultaneous transmission with the SR is not allowed by configuration of simultaneous PUCCH-PUSCH, the UE 104 may consider the SR transmission as a prioritized SR transmission and consider the other overlapping UL grant(s), if any, as a de-prioritized UL grant(s).

In some implementations, for the SR configuration corresponding to the pending SR, the UE 104 transmits the SR to the base station 102 on one valid PUCCH resource for the pending SR and increments SR_COUNTER by 1 per SR configuration if SR_COUNTER is less than sr-TransMax.

In some implementations, for each pending SR trigged for the DSR, for the SR configuration corresponding to the pending SR, the UE 104 increments SR_COUNTER by 1 for per SR configuration.

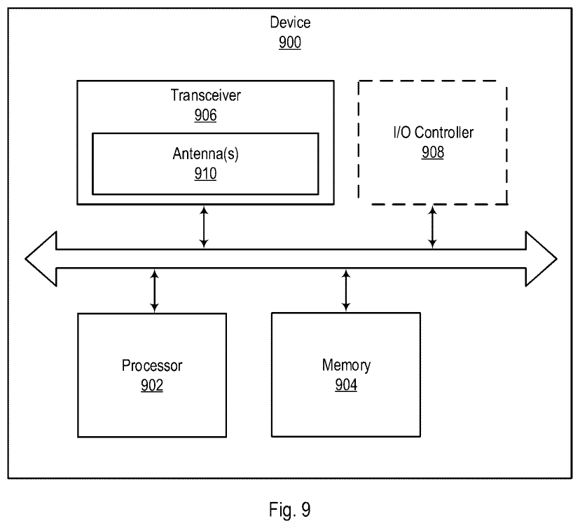

FIG. 9 illustrates an example of a device 900 that supports delay report and discarding based on a synchronization transmission set in accordance with aspects of the present disclosure. The device 900 may be an example of a base station 102 or a UE 104 as described herein. The device 900 may support wireless communication with one or more network entities 102, UEs 104, or any combination thereof. The device 900 may include components for bi-directional communications including components for transmitting and receiving communications, such as a processor 902, a memory 904, a transceiver 906, and, optionally, an I/O controller 908. These components may be in electronic communication or otherwise coupled (e.g., operatively, communicatively, functionally, electronically, electrically) via one or more interfaces (e.g., buses).

The processor 902, the memory 904, the transceiver 906, or various combinations thereof or various components thereof may be examples of means for performing various aspects of the present disclosure as described herein. For example, the processor 902, the memory 904, the transceiver 906, or various combinations or components thereof may support a method for performing one or more of the operations described herein.

In some implementations, the processor 902, the memory 904, the transceiver 906, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 902 and the memory 904 coupled with the processor 902 may be configured to perform one or more of the functions described herein (e.g., executing, by the processor 902, instructions stored in the memory 904).

For example, the processor 902 may support wireless communication at the device 900 in accordance with examples as disclosed herein. The processor 902 may be configured to operable to support a means for performing the following: receiving, at a UE from a base station, at least one SR configuration; triggering a DSR; triggering a first SR for the triggered DSR based on a first SR configuration among the at least one SR configuration; and transmitting the first SR to the base station based on the first SR configuration.

Alternatively, in some implementations, the processor 902 may be configured to operable to support a means for performing the following: transmitting, from a base station to a UE, at least one SR configuration; and receiving from the UE, a first SR triggered for a DSR based on a first SR configuration among the at least one SR configuration.

The processor 902 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 902 may be configured to operate a memory array using a memory controller. In some other implementations, a memory controller may be integrated into the processor 902. The processor 902 may be configured to execute computer-readable instructions stored in a memory (e.g., the memory 904) to cause the device 900 to perform various functions of the present disclosure.

The memory 904 may include random access memory (RAM) and read-only memory (ROM). The memory 904 may store computer-readable, computer-executable code including instructions that, when executed by the processor 902 cause the device 900 to perform various functions described herein. The code may be stored in a non-transitory computer-readable medium such as system memory or another type of memory. In some implementations, the code may not be directly executable by the processor 902 but may cause a computer (e.g., when compiled and executed) to perform functions described herein. In some implementations, the memory 904 may include, among other things, a basic I/O system (BIOS) which may control basic hardware or software operation such as the interaction with peripheral components or devices.

The I/O controller 908 may manage input and output signals for the device 900. The I/O controller 908 may also manage peripherals not integrated into the device M02. In some implementations, the I/O controller 908 may represent a physical connection or port to an external peripheral. In some implementations, the I/O controller 908 may utilize an operating system such as iOS®, ANDROID®, MS-WINDOWS®, OS/2®, UNIX®, LINUX®, or another known operating system. In some implementations, the I/O controller 908 may be implemented as part of a processor, such as the processor 906. In some implementations, a user may interact with the device 900 via the I/O controller 908 or via hardware components controlled by the I/O controller 908.

In some implementations, the device 900 may include a single antenna 910. However, in some other implementations, the device 900 may have more than one antenna 910 (i.e., multiple antennas), including multiple antenna panels or antenna arrays, which may be capable of concurrently transmitting or receiving multiple wireless transmissions. The transceiver 906 may communicate bi-directionally, via the one or more antennas 910, wired, or wireless links as described herein. For example, the transceiver 906 may represent a wireless transceiver and may communicate bi-directionally with another wireless transceiver. The transceiver 906 may also include a modem to modulate the packets, to provide the modulated packets to one or more antennas 910 for transmission, and to demodulate packets received from the one or more antennas 910. The transceiver 906 may include one or more transmit chains, one or more receive chains, or a combination thereof.

A transmit chain may be configured to generate and transmit signals (e.g., control information, data, packets). The transmit chain may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmit chain may also include at least one power amplifier configured to amplify the modulated signal to an appropriate power level suitable for transmission over the wireless medium. The transmit chain may also include one or more antennas 910 for transmitting the amplified signal into the air or wireless medium.

A receive chain may be configured to receive signals (e.g., control information, data, packets) over a wireless medium. For example, the receive chain may include one or more antennas 910 for receive the signal over the air or wireless medium. The receive chain may include at least one amplifier (e.g., a low-noise amplifier (LNA)) configured to amplify the received signal. The receive chain may include at least one demodulator configured to demodulate the receive signal and obtain the transmitted data by reversing the modulation technique applied during transmission of the signal. The receive chain may include at least one decoder for decoding the processing the demodulated signal to receive the transmitted data.

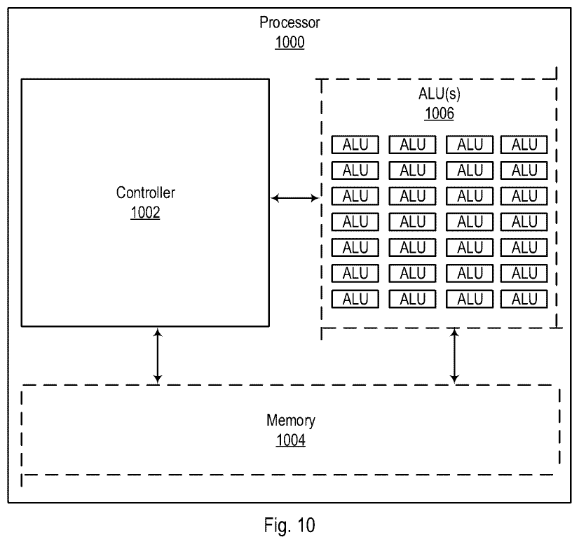

FIG. 10 illustrates an example of a processor 1000 that supports delay report and discarding based on a synchronization transmission set in accordance with aspects of the present disclosure. The processor 1000 may be an example of a processor configured to perform various operations in accordance with examples as described herein. The processor 1000 may include a controller 1002 configured to perform various operations in accordance with examples as described herein. The processor 1000 may optionally include at least one memory 1004, such as L1/L2/L3 cache. Additionally, or alternatively, the processor 1000 may optionally include one or more arithmetic-logic units (ALUs) 1006. One or more of these components may be in electronic communication or otherwise coupled (e.g., operatively, communicatively, functionally, electronically, electrically) via one or more interfaces (e.g., buses).

The processor 1000 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1000) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1002 may be configured to manage and coordinate various operations (e.g., signaling, receiving, obtaining, retrieving, transmitting, outputting, forwarding, storing, determining, identifying, accessing, writing, reading) of the processor 1000 to cause the processor 1000 to support various operations in accordance with examples as described herein. For example, the controller 1002 may operate as a control unit of the processor 1000, generating control signals that manage the operation of various components of the processor 1000. These control signals include enabling or disabling functional units, selecting data paths, initiating memory access, and coordinating timing of operations.

The controller 1002 may be configured to fetch (e.g., obtain, retrieve, receive) instructions from the memory 1004 and determine subsequent instruction(s) to be executed to cause the processor 1000 to support various operations in accordance with examples as described herein. The controller 1002 may be configured to track memory address of instructions associated with the memory 1004. The controller 1002 may be configured to decode instructions to determine the operation to be performed and the operands involved. For example, the controller 1002 may be configured to interpret the instruction and determine control signals to be output to other components of the processor 1000 to cause the processor 1000 to support various operations in accordance with examples as described herein. Additionally, or alternatively, the controller 1002 may be configured to manage flow of data within the processor 1000. The controller 1002 may be configured to control transfer of data between registers, arithmetic logic units (ALUs), and other functional units of the processor 1000.

The memory 1004 may include one or more caches (e.g., memory local to or included in the processor 1000 or other memory, such RAM, ROM, DRAM, SDRAM, SRAM, MRAM, flash memory, etc. In some implementation, the memory 1004 may reside within or on a processor chipset (e.g., local to the processor 1000). In some other implementations, the memory 1004 may reside external to the processor chipset (e.g., remote to the processor 1000).

The memory 1004 may store computer-readable, computer-executable code including instructions that, when executed by the processor 1000, cause the processor 1000 to perform various functions described herein. The code may be stored in a non-transitory computer-readable medium such as system memory or another type of memory. The controller 1002 and/or the processor 1000 may be configured to execute computer-readable instructions stored in the memory 1004 to cause the processor 1000 to perform various functions. For example, the processor 1000 and/or the controller 1002 may be coupled with or to the memory 1004, the processor 1000, the controller 1002, and the memory 1004 may be configured to perform various functions described herein. In some examples, the processor 1000 may include multiple processors and the memory 1004 may include multiple memories. One or more of the multiple processors may be coupled with one or more of the multiple memories, which may, individually or collectively, be configured to perform various functions herein.

The one or more ALUs 1006 may be configured to support various operations in accordance with examples as described herein. In some implementation, the one or more ALUs 1006 may reside within or on a processor chipset (e.g., the processor 1000). In some other implementations, the one or more ALUs 1006 may reside external to the processor chipset (e.g., the processor 1000). One or more ALUs 1006 may perform one or more computations such as addition, subtraction, multiplication, and division on data. For example, one or more ALUs 1006 may receive input operands and an operation code, which determines an operation to be executed. One or more ALUs 1006 be configured with a variety of logical and arithmetic circuits, including adders, subtractors, shifters, and logic gates, to process and manipulate the data according to the operation. Additionally, or alternatively, the one or more ALUs 1006 may support logical operations such as AND, OR, exclusive-OR (XOR), not-OR (NOR), and not-AND (NAND), enabling the one or more ALUs 1006 to handle conditional operations, comparisons, and bitwise operations.

The processor 1000 may support wireless communication in accordance with examples as disclosed herein. The processor 1000 may be configured to operable to support a means for performing the following: receiving, at a UE from a base station, at least one SR configuration; triggering a DSR; triggering a first SR for the triggered DSR based on a first SR configuration among the at least one SR configuration; and transmitting the first SR to the base station based on the first SR configuration.

Alternatively, in some implementations, the processor 1000 may be configured to operable to support a means for performing the following: transmitting, from a base station to a UE, at least one SR configuration; and receiving from the UE, a first SR triggered for a DSR based on a first SR configuration among the at least one SR configuration.

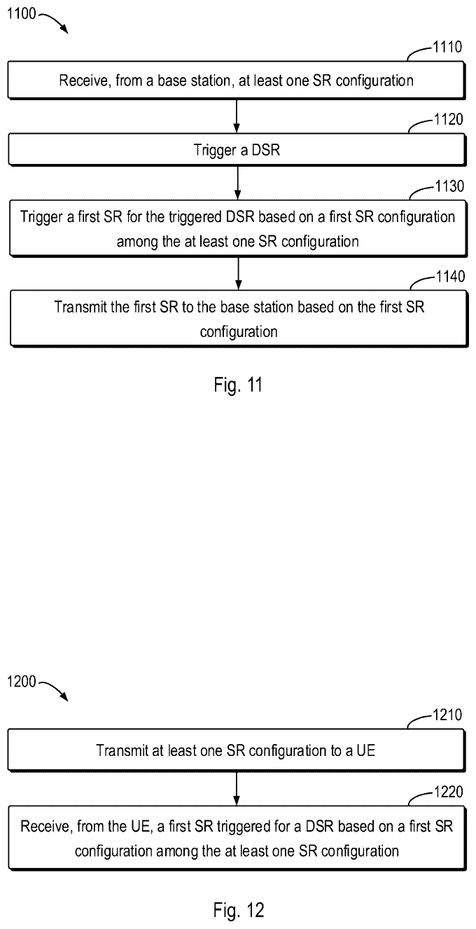

FIG. 11 illustrates a flowchart of a method 1100 that supports handling of an SR triggered for a DSR in accordance with aspects of the present disclosure. The operations of the method 1100 may be implemented by a device or its components as described herein. For example, the operations of the method 11 may be performed by a UE 104 as described herein. In some implementations, the device may execute a set of instructions to control the function elements of the device to perform the described functions. Additionally, or alternatively, the device may perform aspects of the described functions using special-purpose hardware.

At 1110, the method may include receiving, at a UE from a base station, at least one SR configuration. The operations of 1110 may be performed in accordance with examples as described herein. In some implementations, aspects of the operations of 1110 may be performed by a device as described with reference to FIG. 1.

At 1120, the method may include triggering a DSR. The operations of 1120 may be performed in accordance with examples as described herein. In some implementations, aspects of the operations of 1120 may be performed by a device as described with reference to FIG. 1.

At 1130, the method may include triggering a first SR for the triggered DSR based on a first SR configuration among the at least one SR configuration. The operations of 1110 may be performed in accordance with examples as described herein. In some implementations, aspects of the operations of 1110 may be performed by a device as described with reference to FIG. 1.

At 1140, the method may include transmitting the first SR to the base station based on the first SR configuration. The operations of 1110 may be performed in accordance with examples as described herein. In some implementations, aspects of the operations of 1110 may be performed by a device as described with reference to FIG. 1.

FIG. 12 illustrates a flowchart of a method 1200 that supports handling of an SR triggered for a DSR in accordance with aspects of the present disclosure. The operations of the method 1200 may be implemented by a device or its components as described herein. For example, the operations of the method 1200 may be performed by a base station 102 as described herein. In some implementations, the device may execute a set of instructions to control the function elements of the device to perform the described functions. Additionally, or alternatively, the device may perform aspects of the described functions using special-purpose hardware.

At 1210, the method may include transmitting, from a base station to a UE, at least one SR configuration. The operations of 1210 may be performed in accordance with examples as described herein. In some implementations, aspects of the operations of 1210 may be performed by a device as described with reference to FIG. 1.

At 1220, the method may include receiving, from the UE, a first SR triggered for a DSR based on a first SR configuration among the at least one SR configuration. The operations of 1220 may be performed in accordance with examples as described herein. In some implementations, aspects of the operations of 1220 may be performed by a device as described with reference to FIG. 1.

It shall be noted that implementations of the present disclosure which have been described with reference to FIGS. 2 to 8 are also applicable to the device 900, the process 1000 and the methods 1100 and 1200.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and configured to cause the UE to:
receive at least one scheduling request (SR) configuration;
trigger a delay status report (DSR);
trigger a first SR for the triggered DSR based at least in part on a first SR configuration among the at least one SR configuration; and
transmit the first SR based at least in part on the first SR configuration.

2. The UE of claim 1, wherein the first SR configuration is associated with transmission of the first SR triggered for the DSR.

3. The UE of claim 1, wherein each of the at least one SR configuration is associated with one or more logical channels (LCHs), and the first SR configuration is an SR configuration associated with an LCH that triggered the DSR.

4. The UE of claim 1, wherein each of the at least one SR configuration is associated with one or more logical channel groups (LCGs), and the first SR configuration is an SR configuration associated with an LCG that triggered the DSR.

5. The UE of claim 1, wherein to trigger the first SR, the at least one processor is configured to cause the UE to:
trigger the first SR for the triggered DSR based at least in part on a determination that there is no uplink shared channel (UL-SCH) resources available for a new transmission.

6. The UE of claim 1, wherein to trigger the first SR, the at least one processor is configured to cause the UE to:
trigger the first SR for the triggered DSR based at least in part on a determination that uplink shared channel (UL-SCH) resources available for a new transmission do not meet logical channel prioritization (LCP) mapping restrictions configured for a logical channel that triggered the DSR.

7. The UE of claim 1, wherein to trigger the first SR, the at least one processor is configured to cause the UE to:
trigger the first SR for the triggered DSR based at least in part on a determination that at least one configured uplink grant is configured, a regular DSR was triggered for a logical channel, and the logical channel is allowed to trigger the first SR if the at least one configured uplink grant is configured.

8. The UE of claim 1, wherein to trigger the first SR, the at least one processor is configured to cause the UE to:
trigger the first SR for the triggered DSR based at least in part on a determination that that a time gap between triggering of the DSR and a first uplink shared channel (UL-SCH) resource occasion available for a new transmission is greater than or equal to a time threshold.

9. The UE of claim 1, wherein to transmit the first SR, the at least one processor is configured to cause the UE to:
based at least in part on a determination that a first resource for the first SR triggered for the DSR overlaps in time domain with a second resource for a second SR triggered for a buffer status report (BSR), transmit the first SR or the second SR based at least in part on priorities of the first SR and the second SR.

10. The UE of claim 1, wherein to transmit the first SR, the at least one processor is configured to cause the UE to:
based at least in part on a determination that a first resource for the first SR triggered for the DSR overlaps in time domain with a third resource for an uplink grant, transmit the first SR or data according to the uplink grant based at least in part on priorities of the first SR and the uplink grant.

11. The UE of claim 10, wherein the at least one processor is further configured to cause the UE to:
determine a first priority of the first SR as one of:
a highest priority of logical channels (LCHs) with delay status available for transmission when the DSR is triggered,
a priority of a logical channel that triggered the DSR, or
a priority of a medium access control control element (MAC CE) for the DSR.

12. The UE of claim 1, wherein the at least one processor is further configured to cause the UE to:
cancel the first SR based at least in part on a determination that the first SR for the DSR was triggered prior to assembly of a medium access control protocol data unit (MAC PDU) comprising a medium access control control element (MAC CE) for the DSR and the MAC PDU is transmitted.

13. The UE of claim 1, wherein the at least one processor is further configured to cause the UE to:
cancel the first SR triggered for the DSR based at least in part on a determination that at least one uplink grant can accommodate all pending data available for transmission that triggered the DSR.

14. The UE of claim 1, wherein the at least one processor is further configured to cause the UE to:
initiate a random access (RA) procedure for transmission of the first SR for the DSR, the first SR being triggered prior to assembly of a medium access control protocol data unit (MAC PDU) comprising a medium access control control element (MAC CE) for the DSR; and
stop the RA procedure based at least in part on a determination that after the initiation of the RA procedure, the MAC PDU is transmitted based at least in part on an uplink grant which is not allocated by the RA procedure.

15. The UE of claim 1, wherein the at least one processor is further configured to cause the UE to:
initiate a random access (RA) procedure for transmission of the first SR for the DSR, the first SR being triggered prior to assembly of a medium access control protocol data unit (MAC PDU) comprising a medium access control control element (MAC CE) for the DSR; and
stop the RA procedure based at least in part on a determination that after the initiation of the RA procedure, at least one uplink grant can accommodate all pending data available for transmission that triggered the DSR.

16. The UE of claim 15, wherein the MAC CE comprises delay status up to and including a last event that triggered the DSR prior to the assembly of the MAC PDU.

17. A base station for wireless communication, comprising:
at least one memory; and
at least one processor coupled with the at least one memory and configured to cause the base station to:
transmit at least one scheduling request (SR) configuration; and
receive a first SR triggered for a delay status report (DSR) based at least in part on a first SR configuration among the at least one SR configuration.

18. (canceled)

19. A method performed by a user equipment (UE), the method comprising:
receiving at least one scheduling request (SR) configuration;
triggering a delay status report (DSR);
triggering a first SR for the triggered DSR based at least in part on a first SR configuration among the at least one SR configuration; and
transmitting the first SR based at least in part on the first SR configuration.

20. A method performed by a base station, the method comprising:
transmitting at least one scheduling request (SR) configuration; and
receiving a first SR triggered for a delay status report (DSR) based at least in part on a first SR configuration among the at least one SR configuration.

21. The UE of claim 1, wherein the at least one processor is further configured to cause the UE to cancel the first SR trigged by the DSR if the DSR is cancelled.
